(19) United States
(12) Patent Application Publication
(10) Pub. No.: US 2023/0014486 A1
(43) Pub. Date: Jan. 19, 2023

(54) DOOR LOCKS

(71) Applicant: Consumer 2.0 Inc., LOS ANGELES, CA (US)

(72) Inventors: Zhong LIANG, Shenzhen (CN); Xuefeng GU, Shenzhen (CN)

(21) Appl. No.: 17/447,201

(22) Filed: Sep. 9, 2021

(30) Foreign Application Priority Data
Jul. 7, 2021 (CN) 202110764839.2
Jul. 7, 2021 (CN) 202121529528.X

(51) Int. Cl. E05B 63/00; E05B 17/22; E05B 9/08

(52) U.S. Cl. CPC E05B 63/006; E05B 17/226; E05B 9/08; E05B 47/0012

(57) ABSTRACT

In an embodiment, the present application discloses a door lock, comprising: a knob, positioned on a side of a door; a lock body, disposed within the door; and a connecting assembly, comprising a connecting shaft, comprising a front end and an opposite, rear end; and a receiving piece, comprising a connecting shaft receiving portion and a knob receiving portion. The knob receiving portion is configured to fixedly connect to the knob, and the connecting shaft receiving portion is configured to receive and detachably connect to the rear end. In an installed state, the front end acts on at least a part of the lock body to control the open and close of the lock body. The connecting shaft receiving portion and the rear end further have at least two connecting mechanisms in a longitudinal axis direction, so as to adjust the distance between the knob and the lock body. The door lock can adapt to doors of different thicknesses by adjusting the distance between the knob and the lock body.

### CROSS-REFERENCE TO RELATED APPLICATION

This application claims priorities to, and the benefits of, Chinese Invention Patent Application No. filed on 202110764839.2 filed on Jul. 7, 2021 and Chinese Utility Model Patent Application No. 202121529528.X filed on Jul. 7, 2021. The entire content of the foregoing applications is hereby incorporated by reference herein in its entirety.

### FIELD OF INVENTION

The present disclosure relates to the field of locks, and in particular to door locks.

### BACKGROUND OF INVENTION

Door locks are important for safety protection in houses, offices and business places. Since doors are various in thickness specification, a variety of specifications of installation parts are provided for a user in design and sales package of the current door locks, and the user needs to select an installation part having an appropriate length for installation of the door lock; alternatively, the longest installation part is provided for the user, and the user cuts by himself/herself to obtain an appropriate length according to the thickness of the door. However, in any case, there are problems of high material costs, inconvenient installation, etc., causing the convenience and practicability of the door locks to be greatly reduced.

### SUMMARY OF INVENTION

In order to solve the problems, such as wasting material, inconvenient installation, etc. in the prior art, in one aspect, the present application provides a door lock, comprising: a knob, positioned on a side of a door; a lock body, disposed within the door; and a connecting assembly, comprising: a connecting shaft, comprising a front end and an opposite, rear end; and a receiving piece, comprising a connecting shaft receiving portion and a knob receiving portion, wherein the knob receiving portion is configured to fixedly connect to the knob, and the connecting shaft receiving portion is configured to receive and detachably connect to the rear end; in an installed state, the front end acts on at least a part of the lock body to control the open and close of the lock body; and the connecting shaft receiving portion and the rear end further have at least two connecting mechanisms in a longitudinal axis direction, so as to adjust the distance between the knob and the lock body. The door lock can adapt to doors of different thicknesses by adjusting the distance between the knob and the lock body.

In another aspect, the present application provides a door lock, comprising: a knob, positioned on a side of a door; a lock body, disposed within the door; and a connecting assembly, comprising: a connecting shaft, comprising a front end and an opposite, rear end; and a receiving piece, comprising a connecting shaft receiving portion, a knob receiving portion and at least two connecting positions, wherein the knob receiving portion is configured to fixedly connect to the knob receiving portion, and the connecting shaft receiving portion is configured to receive and detachably connect to the rear end; wherein at least a part of the connecting shaft receiving portion is tubular, the center of which is configured with a space corresponding to the shape of the rear end for accommodating the rear end, and comprises at least one side wall; the rear end is further configured with: an end sleeve, sleeved at the rear end, and the end sleeve comprising two opposite side planes; and a spring bead, disposed on at least one of the side planes of the end sleeve; the at least two connecting positions are a first slot and a second slot; when in an installed state, the rear end enters the space of the connecting shaft receiving portion, so at least a portion of the spring bead enters the first slot or the second slot of the side wall of the connecting shaft receiving portion to limit the connecting shaft to one of the connecting positions, thereby adjusting the distance between the knob and the lock body; and the front end acts on at least a part of the lock body to control the open and close of the lock body.

At least one embodiment of the present application has the following advantages: by adjusting the connecting position of the connecting assembly in the door lock, the longitudinal length of the door lock is adjusted to adapt to doors of different thicknesses. Compared with the prior art, the door lock of the present application is simple in structure, the way of combining the spring bead and the slots allows both disassembly and assembly to be convenient, no materials are wasted, and part of components in the door lock do not need to be machined in situ, so that the door lock has remarkable technical progress.

### BRIEF DESCRIPTION OF FIGURES

The performance and advantages of the present disclosure may be further understood with reference to the rest of the specification and the drawings; and identical assemblies in these figures are numbered with the same reference numerals. In some cases, a sub-marker is shown after a reference numeral and hyphen to represent one of many similar assemblies. Any one mentioned reference numeral with an existing sub-marker not specifically identified refers to all such similar assemblies.

FIG. 1 is a schematic exploded diagram of a door lock during installation according to one of the embodiments of the present application.

FIG. 2 is a partial structural schematic diagram of the embodiment shown in FIG. 1.

FIG. 3A is a structural schematic diagram of the embodiment, connected at a first connecting position, shown in FIG. 1.

FIG. 3B is a partially enlarged schematic diagram of FIG. 3A.

FIG. 4A is a structural schematic diagram of the embodiment, connected at a second connecting position, shown in FIG. 1.

FIG. 4B is a partially enlarged schematic diagram of FIG. 4A.

| | | | |
|---|---|---|---|
| 100 | Door lock | 120 | Knob |
| 130 | Connecting assembly | 140 | Lock body |
| 150 | Front panel | 160 | Rear panel |
| 134 | Receiving piece | 131 | Connecting shaft |
| 133 | Spring bead | 132 | End sleeve |
| 135 | First slot | 136 | Second slot |
| 1341 | Connecting shaft receiving | 1342 | Knob receiving portion |
| | portion | | |
| 1312 | Second end | 1311 | First end |
| 1321 | End sleeve hole | 1313 | Second end hole |
| 141 | Lock bar | 137 | Space |
| 170 | Rear cover plate | | |
| 10 | Door | 11 | Door lock installation hole |
| 12 | Front side | 13 | Back side |

### DETAILED DESCRIPTION OF THE PREFERRED EMBODIMENTS

The embodiments are described in greater detail below with reference to the following examples, which are provided herein by way of illustration only and are not intended to be limiting.

The present disclosure has many variations which can be expected by those skilled persons in the art, and the using effects of the present disclosure can be achieved.

The terms defining the space or position of the present application, such as “inner”, “outer”, “upper”, “lower”, “left”, “right”, “top”, “bottom”, “front side” and “back side”, are defined with reference to the placing position of a door lock of this embodiment in the installed state. The terms are only used for describing reference points for the convenience of description and thus will not limit the exemplary embodiments to any particular orientation or configuration.

In the present application, the term “comprising” means including, but not limited to, the following elements, that is, not excluding other elements.

As used herein and in the claims, the term “connecting” refers to the physical combination of one component and another component, either directly or indirectly.

As used herein and in the claims, the terms “generally”, “substantially”, “roughly”, “approximately” and “about” mean that a stated feature, angle, shape, state, structure or value needs not be precisely achieved, but may not exclude deviations or changes in the amount of effect that the feature is intended to provide, including, for example, tolerances, measurement errors, measurement accuracy limitations and other factors known to those skilled persons in the art. For example, an object “generally” perpendicular to an axis, line or surface means that the object is either completely perpendicular to the axis, line or surface or nearly completely perpendicular to the axis, line or surface, for example, having a deviation of 5%.

It will be understood that although the terms such as “first”, “second” and “third” may be used herein to describe various limitations, elements, components, areas, portions, and/or sections, these limitations, elements, components, areas, portions and/or sections should not be limited by these terms. These terms are used merely to distinguish one limitation, element, component, area, portion or section from another limitation, element, component, area, portion or section. Thus, a first limitation, element, component, area, portion or section discussed below may be referred to as a second limitation, element, component, area, portion or section without departing from the teachings of the present disclosure.

In the present application, the term “rear panel” refers to a support structure disposed correspondingly on the back side of a door and forming a main profile of the rear side of the door lock, but it is not limited to a planar structure. For example, a “rear panel” may include a planar or non-planar portion.

In one aspect, the present application provides a door lock, comprising: a knob, positioned on a side of a door; a lock body, disposed within the door; and a connecting assembly, comprising: a connecting shaft, comprising a front end and an opposite, rear end; and a receiving piece, comprising a connecting shaft receiving portion and a knob receiving portion, wherein the knob receiving portion is configured to fixedly connect to the knob, and the connecting shaft receiving portion is configured to receive and detachably connect to the rear end; in an installed state, the front end acts on at least a part of the lock body to control the open and close of the lock body; and the connecting shaft receiving portion and the rear end further have at least two connecting mechanisms in a longitudinal axis direction, so as to adjust the distance between the knob and the lock body. The door lock can adapt to doors of different thicknesses by adjusting the distance between the knob and the lock body.

In an embodiment, the connecting mechanisms are or comprise at least two connecting positions disposed on the connecting shaft receiving portion, and a connecting device disposed at the rear end; and any one of the connecting positions is matingly engaged with the connecting device, and the engagement of different connecting positions and the connecting device may allow different longitudinal lengths of the door lock to adapt to doors of different thicknesses.

In an embodiment, the connecting mechanisms are or comprise at least two connecting positions disposed at the rear end, and a connecting device disposed on the connecting shaft receiving portion; and any one of the connecting positions is matingly engaged with the connecting device.

In an embodiment, the connecting shaft receiving portion is configured with a space corresponding to the shape of the rear end for accommodating the rear end, and comprises at least one side wall.

In an embodiment, the connecting device further comprises a spring bead disposed at the rear end; the at least two connecting positions are a first slot and a second slot which are disposed on the side wall of the connecting shaft receiving portion; and in an installed state, at least a portion of the rear end enters the space of the connecting shaft receiving portion, so that at least a portion of the spring bead is received in the first slot or the second slot of the side wall of the connecting shaft receiving portion to limit the connecting shaft to one of the connecting positions, thereby achieving connection at different connecting positions.

In an embodiment, the connecting device further comprises an end sleeve sleeved at the rear end to fix the spring bead.

In an embodiment, the end sleeve comprises two opposite side planes, and at least one of the side planes is configured with a spring bead.

In an embodiment, one side plane of the end sleeve is configured with a spring bead, the connecting shaft receiving portion comprises two opposite side planes, and the two side planes are configured with a first slot and a second slot. When the connecting shaft is inserted into the connecting shaft receiving portion, the direction of the spring bead does not need to be adjusted, and the spring bead can be connected to the first slot or the second slot no matter from which side plane the spring bead is inserted into the connecting shaft receiving portion.

In an embodiment, the door lock further comprises: a front panel, disposed on the outside of a door; and a rear panel, disposed on the inside of the door; wherein the knob receiving portion passes through the rear panel to be connected to the knob, and when the knob is rotated, the connecting assembly rotates with the knob.

In an embodiment, the lock body further comprises a lock bar, and when the connecting assembly is driven to rotate, the lock bar of the lock body is driven to pop out or retract.

In an embodiment, the front panel may further comprise a screen for inputting an instruction to drive the lock body, for example, an unlocking password.

In an embodiment, the door lock further comprises a motor assembly to drive the lock body.

Another aspect of the present application provides a door lock, comprising: a knob, positioned on a side of a door; a lock body, disposed within the door; and a connecting assembly, comprising: a connecting shaft, comprising a front end and an opposite, rear end; and a receiving piece, comprising a connecting shaft receiving portion, a knob receiving portion and at least two connecting positions, wherein the knob receiving portion is configured to fixedly connect to the knob receiving portion, and the connecting shaft receiving portion is configured to receive and detachably connect to the rear end; wherein at least a portion of the connecting shaft receiving portion is tubular, the center of which is configured with a space corresponding to the shape of the rear end for accommodating the rear end, and comprises at least one side wall; the rear end is further configured with: an end sleeve, sleeved at the rear end, and the end sleeve comprising two opposite side planes; and a spring bead, disposed on at least one of the side planes of the end sleeve; the at least two connecting positions are a first slot and a second slot; in an installed state, the rear end enters the space of the connecting shaft receiving portion, so that at least a portion of the spring bead is received in the first slot or the second slot of the side wall of the connecting shaft receiving portion to limit the connecting shaft to one of the connecting positions, thereby adjusting the distance between the knob and the lock body; and the front end acts on at least a part of the lock body to control the open and close of the lock body.

In an embodiment, the connecting shaft receiving portion comprises two opposite side walls, and the two side walls are configured with a first slot and a second slot. In an embodiment, the door lock further comprises a front panel, and the front panel may further comprise a screen for inputting an instruction to drive the lock body, for example, an unlocking password.

In an embodiment, the door lock further comprises a motor assembly to drive the lock body.

In the present application, the term “front panel” refers to a support structure disposed correspondingly on the front side of a door and forming a main profile of the front side of the door lock, but it is not limited to a planar structure. For example, the “front panel” may include a planar or non-planar portion.

The embodiments of the present application are further described in detail below with reference to the accompanying drawings.

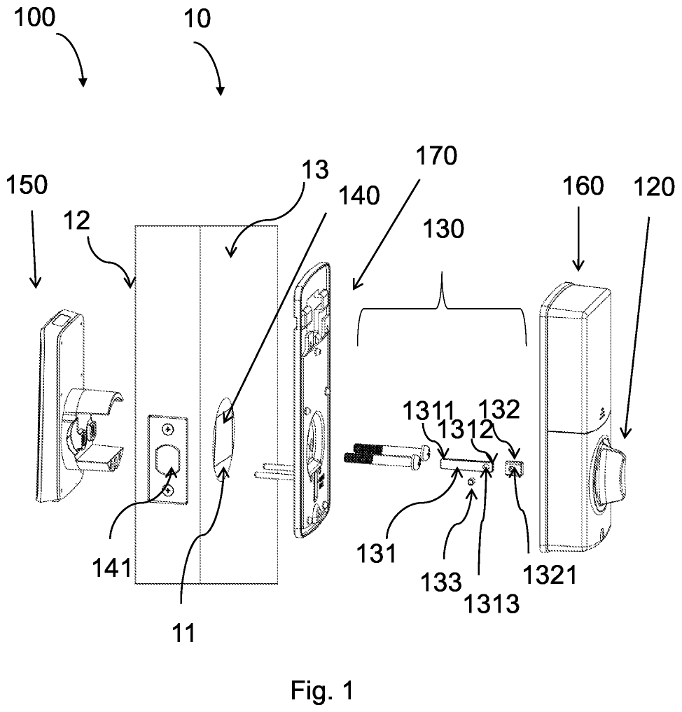

FIG. 1 shows an exploded diagram of a door lock 100 according to one of the embodiments of the present application when installed on a door 10. As shown in FIG. 1, the door 10 has a front side 12 (for example, facing outdoors) and an opposite, back side 13 (for example, facing indoors). The door 10 is further configured with a door lock installation hole 11 penetrating therethrough. The door lock 100 generally comprises a lock body 140 (partially shown), a connection assembly 130, a knob 120, a front panel 150, and a rear panel 160. Optionally, the door lock 100 may further comprise a rear cover plate 170 fixedly connected to the back side 13 and matably connected to the rear panel 160. The rear panel 160 and the rear cover plate 170 are connected to form a rear panel assembly defining a space capable of accommodating the connecting assembly 130 therein. The lock body 140 is disposed within a door lock installation hole 11. The shape of the lock body 140 and its placing position in the door lock installation hole shown in FIG. 1 are only illustrative to facilitate the description of the relative positional relationship of the lock body with other components. Different shapes and installation positions may be made according to the actual situations. The front panel 150 may be positioned on the front side 12 of the door 10, and the rear panel 160 may be positioned on the back side 13 of the door 10. The knob 120 and the rear panel 160 are positioned on the same side of the door (namely the back side 13), and the knob 120 is configured to combine with the rear panel 160 and to be rotatable relative to the rear panel 160. A part of the knob 120 can penetrate through a knob setting hole (not shown in FIG. 1) in the rear panel 160 and is connected and fixed to the lock body 140 by means of the connecting assembly 130.

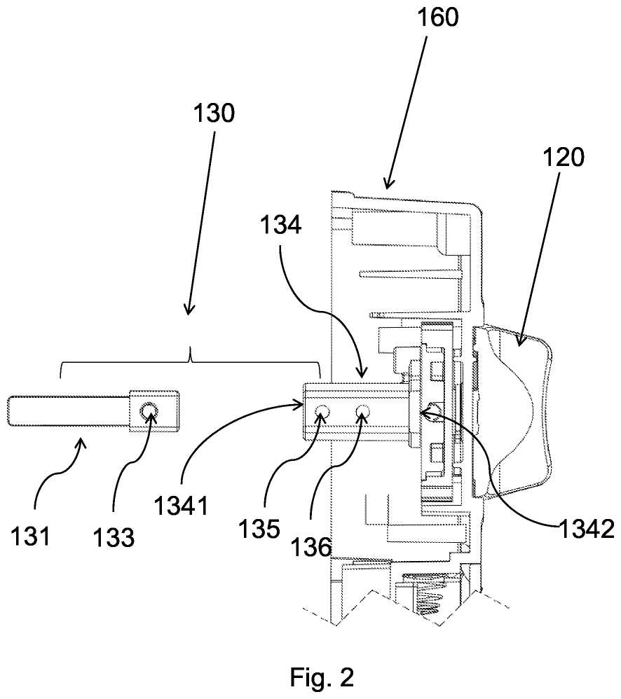

As further shown in FIG. 1, the connecting assembly 130 comprises a connecting shaft 131 and a receiving piece 134. The connecting shaft 131 may be elongated on the whole in this embodiment, and the connecting shaft 131 comprises a first end 1311 (front end) and a second end 1312 (rear end), the first end 1311 being used for connecting to the lock body 140, and the second end 1312 being used for connecting to the receiving piece 134. The second end 1312 is configured with a second end hole 1313, and the second end 1312 is sleeved with an end sleeve 132. At least one side wall of the end sleeve 132 is also configured with an end sleeve hole 1321, as shown in FIG. 1. The connecting shaft 131 may be made of metal. As shown in FIG. 2, the end sleeve 132 can be sized and shaped to sleeve the second end 1312, and the end sleeve hole 1321 and the second end hole 1313 may coincide such that the spring bead 133 may be disposed within the space defined by the end sleeve hole 1321 and the second end hole 1313. At least a portion of the spring bead 133 may protrude to a certain height from the side wall of the end sleeve 132 in a non-external-force compressed state.

In an embodiment, the manner of fixing the spring bead to the connecting shaft is riveting.

In another embodiment, the manner of fixing the spring bead to the connecting shaft is welding.

In another embodiment, both sides of the end sleeve are configured with end sleeve holes, and the end sleeve holes on the both sides are respectively configured with spring beads.

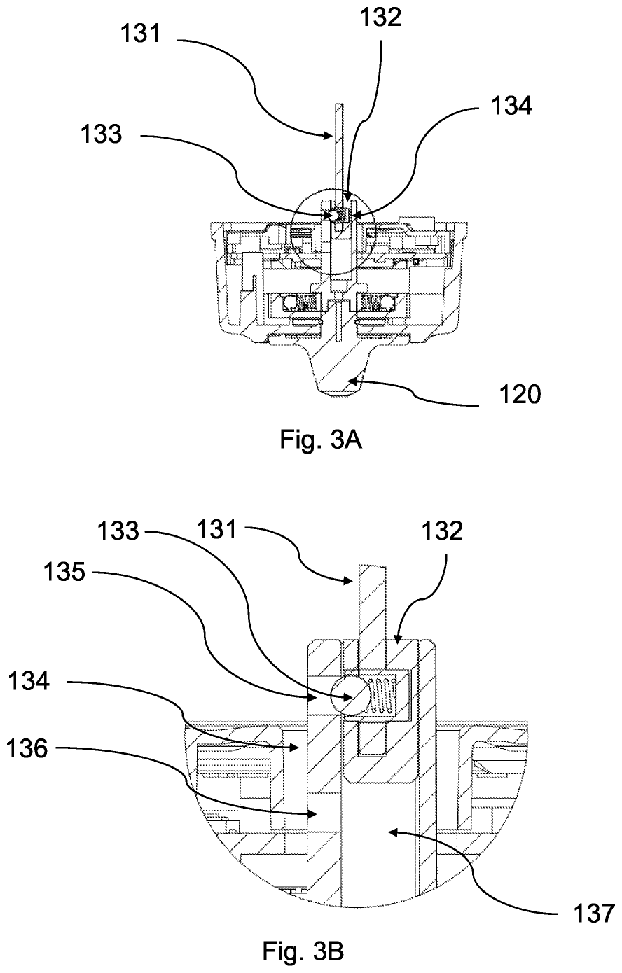

As shown in FIG. 2, the receiving piece 134 in the connecting assembly 130 may also be of an elongated structure on the whole, one end of which is a connecting shaft receiving portion 1341, and the other end of which is a knob receiving portion 1342. The connecting shaft receiving portion 1341 may be tubular with its center having a space 137 (not shown, as will be more clearly shown in FIG. 3) sized and shaped to accommodate the second end 1312 of the connecting shaft 131 and the end sleeve 132 thereon. The knob receiving portion 1342 is fixedly connected to the knob 120 in any manner of end fixing and connecting technique known in the art, for example, including but not limited to, threading, welding and gluing. The receiving piece 134 is further configured with two connecting positions, wherein the connecting positions may be a first slot 135 and a second slot 136 formed in the outer wall of the connecting shaft receiving portion 1341. The first slot 135 and the second slot 136 may be circular corresponding to the shape of the spring bead 133.

In another embodiment, two opposite side walls of the connecting shaft receiving portion 1341 are configured with a first slot and a second slot, and a spring bead is disposed on one side of the end sleeve. In another embodiment, spring beads are disposed on both sides of the end sleeve, and one side wall of the connecting shaft receiving portion is configured with a first slot and a second slot, so that the directions of the spring beads do not need to be adjusted when the connecting shaft is inserted into the connecting shaft receiving portion, that is, the spring beads can be connected to the first slot or the second slot no matter from which side plane the spring beads are inserted into the connecting shaft receiving portion, bringing convenience for a user to use.

In another embodiment, the receiving piece may be configured with more than two (for example, three, four, five or more) connecting positions, and the outer wall of the connecting shaft receiving portion may have a corresponding number of slots (for example, a third slot, a fourth slot, a fifth slot, etc.). That is, two or more connecting positions are provided according to the thickness of the door.

FIGS. 3A and 3B show a cross-sectional schematic diagram and a partially enlarged cross-sectional schematic diagram illustrating the second end 1312 of the connecting shaft 131 inserted into the first connecting position of the receiving piece 134. A force is applied to make the end sleeve 132 enter the space 137, and since at least a part of the spring bead 133 protrudes out of the side wall of the end sleeve 132 in a non-compressed state, the spring bead 133 is temporarily compressed into the end sleeve 132 under the constraint of the size and shape of the connecting shaft receiving portion 1341, so that the end sleeve 132 carrying the spring bead 133 enters the space 137. In this embodiment, due to the large thickness of the door 10, the connecting shaft 131 and the receiving piece 134 need to be connected in the first slot 135. During installation, when the spring bead on the connecting shaft 131 passes through the first slot 135 in the receiving piece 134, the force application is stopped to allow the spring bead to move inwards, the spring bead 133 pops out and is partially received in the first slot 135, and the connecting shaft is limited to the first connecting position, thereby achieving connection of the connecting shaft 131 and the receiving piece 134 in the first connecting position.

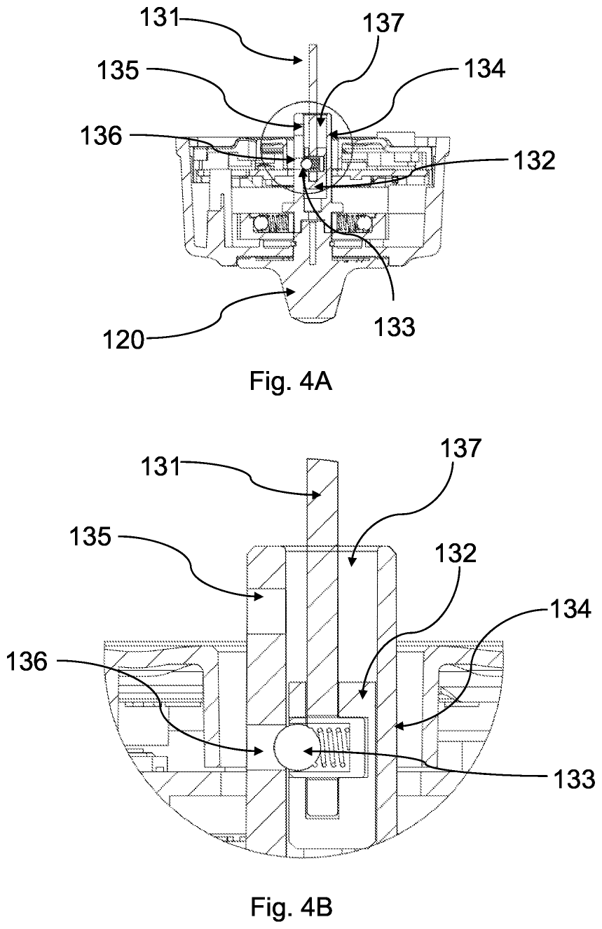

FIGS. 4A and 4B show a schematic diagram and a partially enlarged schematic diagram illustrating the second end of the connecting shaft 131 inserted into the second connecting position of the receiving piece 134. A force is applied to make the end sleeve 132 enter the space 137, and the spring bead is temporarily compressed into the end sleeve 132 under the constraint of the size and shape of the connecting shaft receiving portion 1341, so that the end sleeve 132 carrying the spring bead 133 enters the space 137. In this embodiment, due to the relatively small thickness of the door 10, the connecting shaft 131 and the receiving piece 134 need to be connected in the second slot 136. During installation, after the spring bead on the connecting shaft 131 passes through the first slot 135 in the receiving piece 134, the force application continues to make the spring bead pass through the first connecting position and continue to move inwards until the spring bead moves to the second slot 136, the spring bead 133 pops out and is partially received in the second slot 136, and the connecting shaft is limited to the second connecting position, thereby achieving the connection of the connecting shaft 131 and the receiving piece 134 in the second connecting position.

The connecting position of the connecting shaft 131 and the receiving piece 134 may be arranged on the back side (namely, the indoor side) of the door, ensuring the safety of the door lock, and making the door lock difficultly damaged from the outside of the door.

In some embodiments, both sides of the end sleeve may be configured with spring beads, and one side of the receiving piece may be configured with two or more connecting positions; alternatively, one side of the end sleeve may be configured with a spring bead, but both sides of the receiving piece are configured with two or more groups of connecting positions, so that the end sleeve can be inserted and connected with at least one connecting position therein without adjusting the direction when being inserted into the receiving piece, thereby greatly facilitating installation.

In some embodiments, the front panel may further comprise a screen, such as a touch screen, for inputting an unlocking password to drive the lock body.

In some embodiments, the lock body may be a motor-driven lock body.

In some embodiments, the connecting assembly 130 may rotate with rotation of the knob 120, thereby driving a lock bar 141 to pop out or retract, and accordingly achieving the open and close of the door lock 140 from the inside of the door.

In another embodiment, the connecting assembly may be provided in an opposite manner, for example, by providing a plurality of slots in the second end of the connecting shaft and providing a spring bead on the receiving piece, and when the connecting shaft is inserted into the receiving piece, one of the slots is connected to the spring bead in the receiving piece, thereby achieving connection in different connecting positions.

The exemplary embodiments in this description provide methods by way of example only, and examples of one method are not intended to limit examples of another method. A device/method illustrated in a figure may be added to or exchanged with devices/methods in other figures. Furthermore, specific digital data values (for example, specific numbers, quantities, categories, etc.) or other specific information are used merely to describe the exemplary embodiments and are not intended to limit the exemplary embodiments with such specific information.

What is claimed is:

1. A door lock, comprising
(a) a knob, positioned on a side of a door;
(b) a lock body, disposed within the door; and
(c) a connecting assembly, comprising
(i) a connecting shaft, comprising a front end and an opposite, rear end; and
(ii) a receiving piece, comprising a connecting shaft receiving portion, and a knob receiving portion,
the knob receiving portion is configured to fixedly connect to the knob, and the connecting shaft receiving portion is configured to receive and detachably connect to the rear end;
wherein in an installed state, the front end acts on at least a part of the lock body to control the open and close of the lock body;
the connecting shaft receiving portion and the rear end further comprises at least two connecting mechanisms in the longitudinal axis direction, so as to adjust the distance between the knob and the lock body.

2. The door lock according to claim 1, wherein
the at least two connecting mechanisms comprises at least two connecting positions disposed on the connecting shaft receiving portion, and a connecting device disposed on the rear end, any one of the connecting positions is matingly engaged with the connecting device.

3. The door lock according to claim 1, wherein
the at least two connecting mechanisms comprises at least two connecting positions disposed on the rear end, and a connecting device disposed on the connecting shaft receiving portion, any one of the connecting positions is matingly engaged with the connecting device.

4. The door lock according to claim 2, wherein the connecting shaft receiving portion is configured with a space corresponding to the shape of the rear end for accommodating the rear end, and comprises at least one side wall.

5. The door lock according to claim 4, wherein
the connecting device comprises
a spring bead, disposing at the rear end;
the at least two connecting positions are a first slot and a second slot on the side wall of the connecting shaft receiving portion;
wherein, in an installed state, at least a portion of the rear end entering the space of the connecting shaft receiving portion, so that at least a portion of the spring bead is received in the first slot or the second slot of the side wall of the connecting shaft receiving portion, to limit the connecting shaft to one of the connecting positions, thereby achieving connection at different connecting positions.

6. The door lock according to claim 5, wherein the connecting device further comprises an end sleeve, disposing on the rear end to fix the spring bead.

7. The door lock according to claim 6, wherein the end sleeve comprises two opposite side planes, and at least one of the side planes is configured to fix the spring bead.

8. The door lock according to claim 7, wherein the connecting shaft receiving portion comprises two opposite side walls, and the two side walls are configured with the first slot and the second slot.

9. The door lock according to claim 1, further comprising
a front panel, disposed on the outside of the door; and
a rear panel, disposed on the inside of the door;
wherein the knob receiving portion passes through the rear panel to connect with the knob, and when the knob rotates, the connecting assembly rotates with the knob.

10. The door lock according to claim 1, wherein the lock body comprises a lock bar, when the connecting assembly is driven to rotate, the lock bar is driven to pop out or retract.

11. The door lock according to claim 9, the front panel further comprises a screen for inputting an unlocking instruction to drive the lock body.

12. The door lock according to claim 1, further comprising a motor assembly to drive the lock body.

13. A door lock, comprising
(a) a knob, positioned on a side of a door;
(b) a lock body, disposed within the door; and
(c) a connecting assembly, comprising
(i) a connecting shaft, comprising a front end and an opposite, rear end; and
(ii) a receiving piece, comprising a connecting shaft receiving portion, a knob receiving portion and at least two connecting positions,
wherein the knob receiving portion is configured to fixedly connect with the knob, and the connecting shaft receiving portion is configured to receive and detachably connect with the rear end;
wherein at least a portion of the connecting shaft receiving portion is tubular, the center of which is configured with a space corresponding to the shape of the rear end for accommodating the rear end, and includes at least one side wall;
the rear end is further configured with
an end sleeve, sleeved at the rear end, and the sleeve comprising two opposite side planes; and
a spring bead, disposed on at least one of the side planes of the end sleeve;
wherein the at least two connecting positions are a first slot and a second slot;
when in an installed state, the rear end enters the space of the connecting shaft receiving portion, so that at least a portion of the spring bead is received in the first slot or the second slot of the side wall of the connecting shaft receiving portion to limit the connecting shaft to one of the connecting positions, thereby adjusting the distance between the knob and the lock body; wherein the front end acts on at least a part of the lock body to control the open and close of the lock body.

14. The door lock according to claim 13, wherein the connecting shaft receiving portion comprises two opposite side walls, and the two side walls are disposed with the first slot and the second slot.

15. The door lock according to claim 13, further comprising a front panel, the front panel further comprises a screen for inputting an instruction to drive the lock body.

16. The door lock according to claim 13, further comprising a motor assembly to drive the lock body.
